(19) United States
(12) Patent Application Publication
(10) Pub. No.: US 2004/0248567 A1
(43) Pub. Date: Dec. 9, 2004

(54) Console for control of media systems

(76) Inventors: Helgi G. Sigurdsson, Kopavogur (IS); Johannes Thordarson, Reykjavik (IS)

Correspondence Address: BIRCH STEWART KOLASCH & BIRCH, PO BOX 747, FALLS CHURCH, VA, 22040-0747, US

(21) Appl. No.: 10/861,457

(22) Filed: Jun. 7, 2004

Related U.S. Application Data
(60) Provisional application No. 60/475,914, filed on Jun. 5, 2003.

(51) Int. Cl. H04M 3/00

(52) U.S. Cl. 455/418; 455/575.1

(57) ABSTRACT

A control console for a video player, such as a DVD player. The console comprises a first group of sensors and a second group of sensors and a communication device for transmitting control signals to the DVD player. Several cards are provided. One card is arranged adjacent the console covering a surface area thereof. The card has slots for cooperation with the first group of sensors. The card also has figures covering the second group of sensors. When a child presses one of the figures, the corresponding button is activated and emits a signal for control of the DVD player. In programming mode, the signal controls the console itself for adapting the console to the DVD player actually used. There is also a programming mode using the DVD player's normal remote control for learning purpose.

### AREA OF INVENTION

The present invention relates to a console for remote control of a video system, in particular a DVD player. The console is adapted for interactive control of the video system.

### BACKGROUND OF INVENTION

Interactive control of various multimedia computers is presently of increasing interest. Often video players like DVD players offer good quality entertainment. Thus, DVD-video has been synonymous with quality. Such video systems are frequently controlled by remote controls. However, such remote controls are seldom well suited for operation by children. However, with a remote control adapted for control by children, they and their family can share an interactive experience like never before, comfortably sitting in the living room enjoying high definition picture and sound. No keyboard, mouse, uncomfortable chair, tiny screen and noisy surrounding.

Thus, there is a need for such a remote console or control. In order to be adapted for children control, such a console may comprise picture cards overlaying control areas, so that children may control the console based on picture rather than text matters or numbers.

EP-A1-1120704 discloses a controller for executing interactive software in a multimedia computer through the use of a plurality of picture cards. Each picture card may have an identifying mark thereon and the controller further comprises a detector for monitoring the identifying mark. The detector generates a switching signal when the identifying mark is changed. However, such a controller must be reprogrammed for each individual apparatus it shall be used with. Currently there is no convenient way to do such reprogramming, so that a new controller has to be obtained for every new equipment to be operated.

If the console is to be used for DVD players, there is no standard for the remote control of such DVD players, which means that every manufacturer has a specific idea of the best way to use the remote control.

Thus, there is a need for a method of reprogramming a console that should be used for controlling a DVD player, to be able to use the same console to different DVD players of different brands.

### SUMMARY OF INVENTION

The present invention provides a new platform for reusing different linear video content, adapted and developed further for interactive use. The video content can be based, created or adapted from any kind of video and/or sound material, animated or not, accompanied by a sound track or not. The interactivity can be navigation, direction, questions and answers, hiding games, educational lessons, etc. Certain themes, i.e., education, entertainment, karaoke, memorizing game, decision making game, traffic lessons, cooking lessons, countering, gymnastic, languages can be used.

Still picture and fairytale (stories), wherein the selection of a still picture will focus on some part of the theme providing explanation to the selected material.

A first object of the invention is to provide a console for a video system that is capable of being adapted to different video systems having different sets of remote control signals.

A second object of the invention is to provide a console that is adapted for use by children from about 2 years old.

A third object is development of video content to match with the sensor cards.

According to the invention, the console comprises a first group of sensors and a second group of sensors and a communication device for transmitting and receiving control signals, for example to a video system. Several control modules are provided and each module is adapted to cooperate with the second group of sensors for identifying the module with the first group of sensors for emitting control signals from the console as well as receiving signals, as in the “learning mode” of the programming.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Other objects, features and advantages of the invention will appear from the following detailed description of embodiments of the invention with reference to the appended drawings, which are given by way of illustration only, and thus are not limitative of the present invention, and in which:

FIG. 1 is a plan view of a console according to the invention.

FIG. 2 is plan view of a console kit comprising the console and a number of cards (navigation modules).

FIG. 3 is a view similar to FIG. 1 and showing a card navigation modules inserted in the console and how the combination reference is designed.

FIG. 4 discloses how the content is stored on a DVD disk.

FIG. 5 demonstrates the function of the console in relation to the contents of the disk.

FIG. 6 discloses the sensors on the device and magnetic buttons on the card.

FIG. 7 discloses a programming of a simple quiz game.

FIG. 8 demonstrates the programming for an animated story.

FIG. 9 discloses the programming for a multi-level quiz game.

### DETAILED DESCRIPTION OF EMBODIMENTS

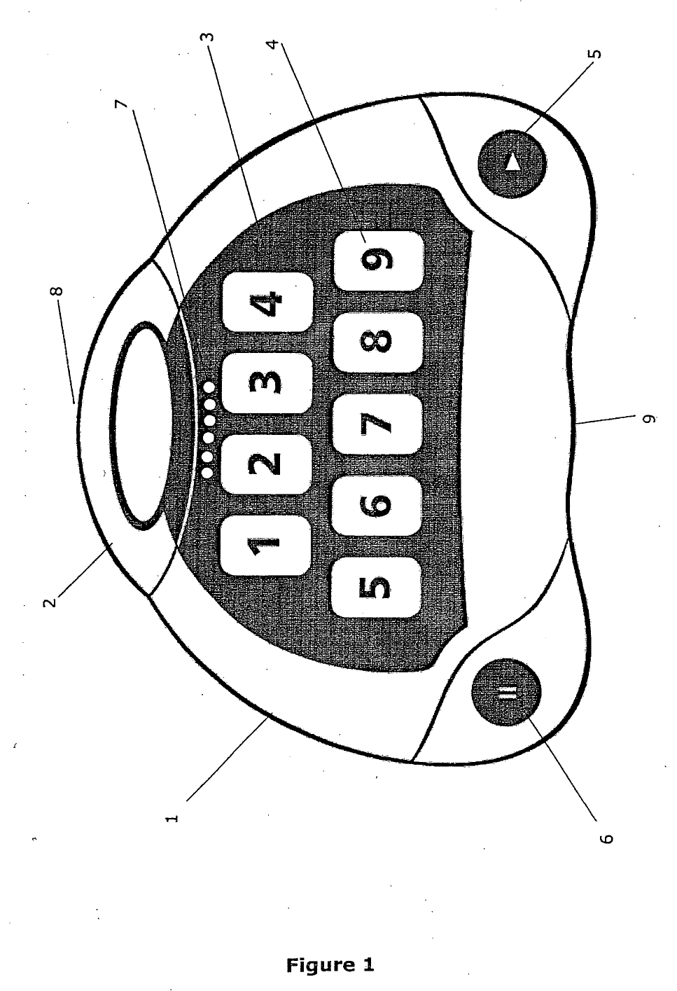

FIG. 1 is a plan view of an embodiment of the console according to the invention. The console is shaped in a convenient way so that a child may easily operate it. It may have rounded corners as appears from FIG. 1. The console comprises a body (1) provided with a handle grip (2).

The console has an area (3) or recess intended to receive cassettes or cards or navigation modules for controlling the console. The recess is provided with nine button areas (4). A pressure on each button area results in the activation of a contact to emit a signal. The button area can be touch screen and the control module can be a cassette with data or receiver for data with pictures or images for the touch screen related to the content. Moreover, there are two large buttons (5) and (6), designated play and pause. They may be designated to other purposes as well.

At the bottom of the area (3), there are six card sensors (7), to be described below. The sensors may be mechanical contacts, magnetic or light sensors. Furthermore, the console comprises an infrared transmitter (8) and an infrared receiver (9).

The console is provided as a kit for remote control of, for example, a DVD player. Other devices showing video may as well be controlled by the console, such as a tape video player, multimedia computers, etc. Below, an embodiment for the control of a DVD player will be described.

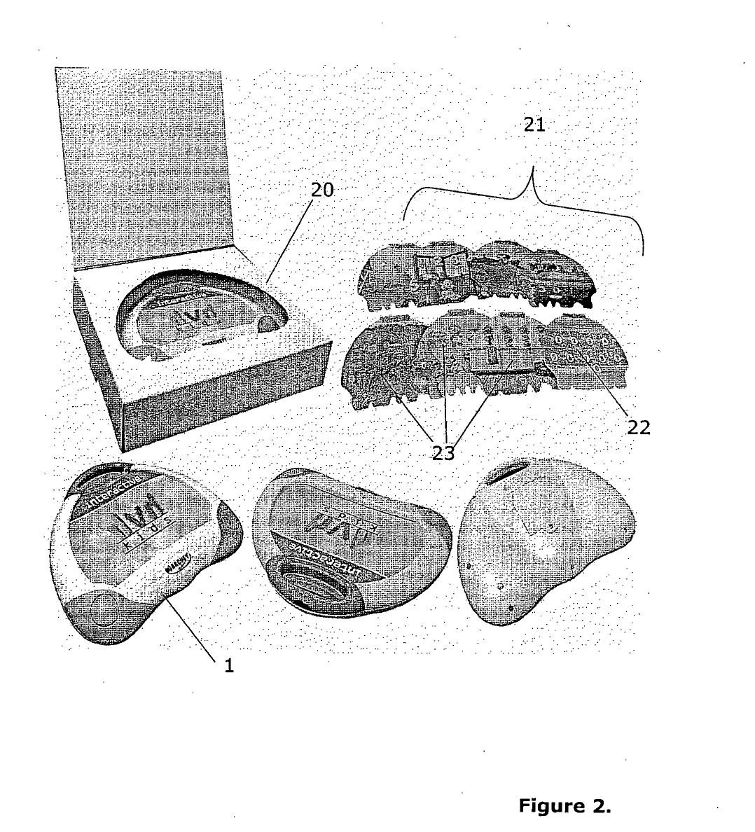

FIG. 2 discloses a kit comprising a console (1) in a package (20), as well as 8 cards (21). One of the cards (22) is a programming card. The cards are provided with slots 23 in the bottom surface for cooperation with said sensors (7) of the console.

The cards can also be fitted with magnetic sensors, which match with magnetic clutches in the device. When the user inserts and releases a card, the card will be forced into the right place by the magnetic. Sensors on the panel can be activated by this force instead of the user force by inserting the card.

The sensors can also be in barcode format with barcode reader installed or light detecting unit.

The cards are provided with motives or figures covering the areas above the nine button areas (4). A child may press a certain figure to active the button there below. The motive may be coordinated with the interactive film or moving picture of the DVD player disc.

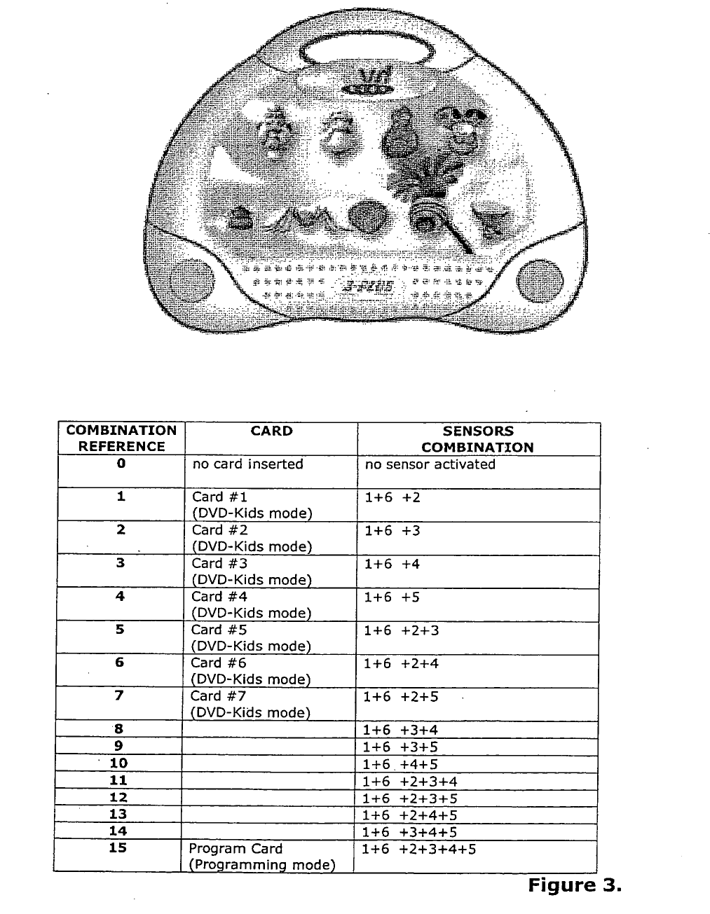

FIG. 3 discloses a card inserted in the console and how the combination reference is designed. The table below the picture shows how different sensor combination, based on the card placed in the device, can be used to initiate different functions.

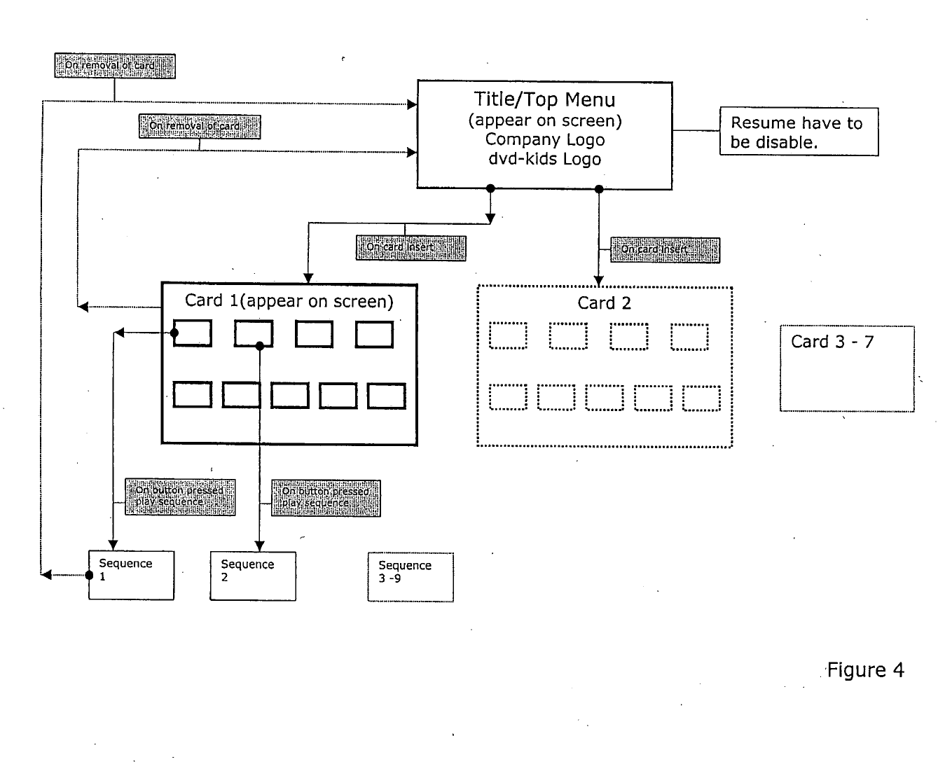

FIG. 4 discloses how the content is stored on a DVD disk. The figure shows the display on the monitor or TV screen 100 when there is no card in the console, or when a card is removed from the console. The display may show a company logo or the DVD-kids logo, for example. In the present context, the disk holds content for 7 cards. As a card 1 is inserted into the console the image of card 1 is displayed on the screen. Once a button is pressed, like, for-example, button 101, asequence 1 is started. If button 102 is pressed, sequence two is initiated, etc. The same goes for cards 2-7.

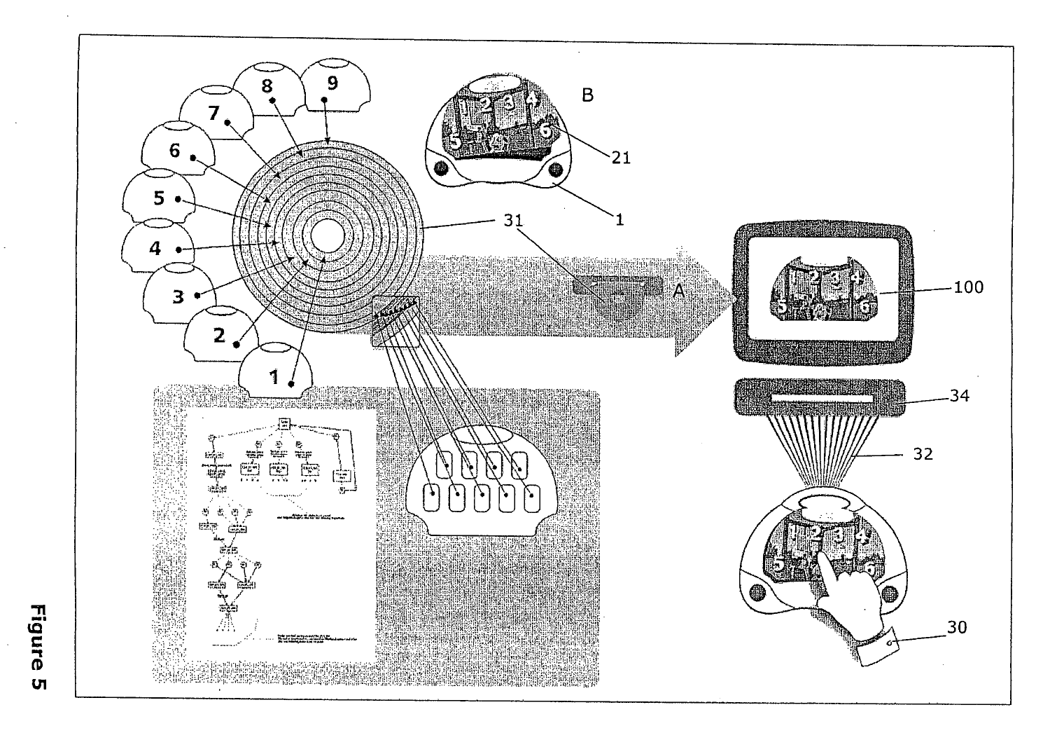

FIG. 5 demonstrates the function of the console and how the cards operate together with the programmed disk 3(1). The disk is inserted into the DVD player (A) and the picture card is placed on to the console (B). Each card represents one area on the disk and within each area of the disk are sub areas, which correspond to each button. The figure shows how the display on the TV screen (100) represents the picture on the card (23), which is inserted onto the console. As the player 30 presses a button under a image on the card, an IR signal 32 is sent is sent to the DVD player 34 and the DVD player shows the command on the TV screen 100 and a sequence is initiated.

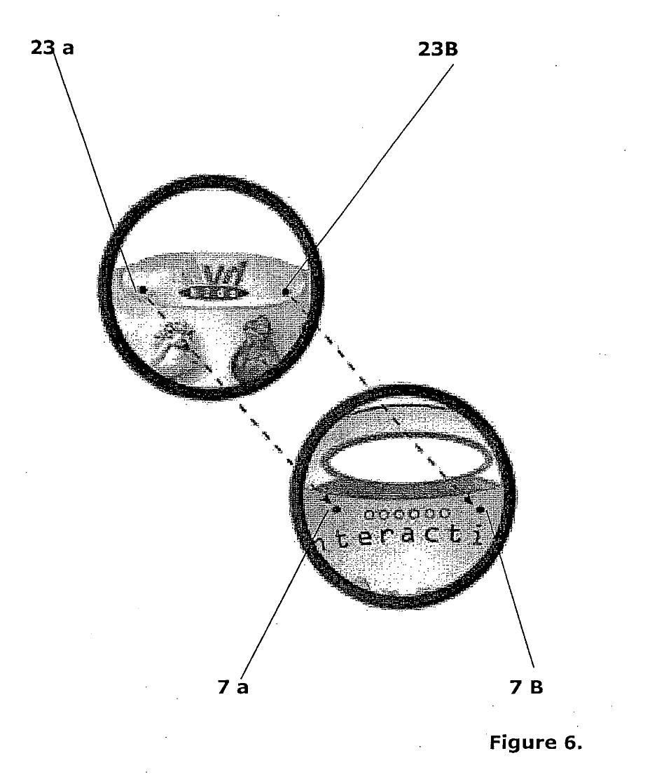

FIG. 6 discloses the sensors on the device and magnetic buttons on the card. The card has two magnetic buttons (23a) and (23b) that leaves the corresponding sensors (7a) and (7b) inactivated. Thus, the remaining sensors are activated. The activated sensors define the card number. The console may emit a signal when the sensors are activated. In the embodiment, a first and sixth sensors are always activated indicating the presence of a card.

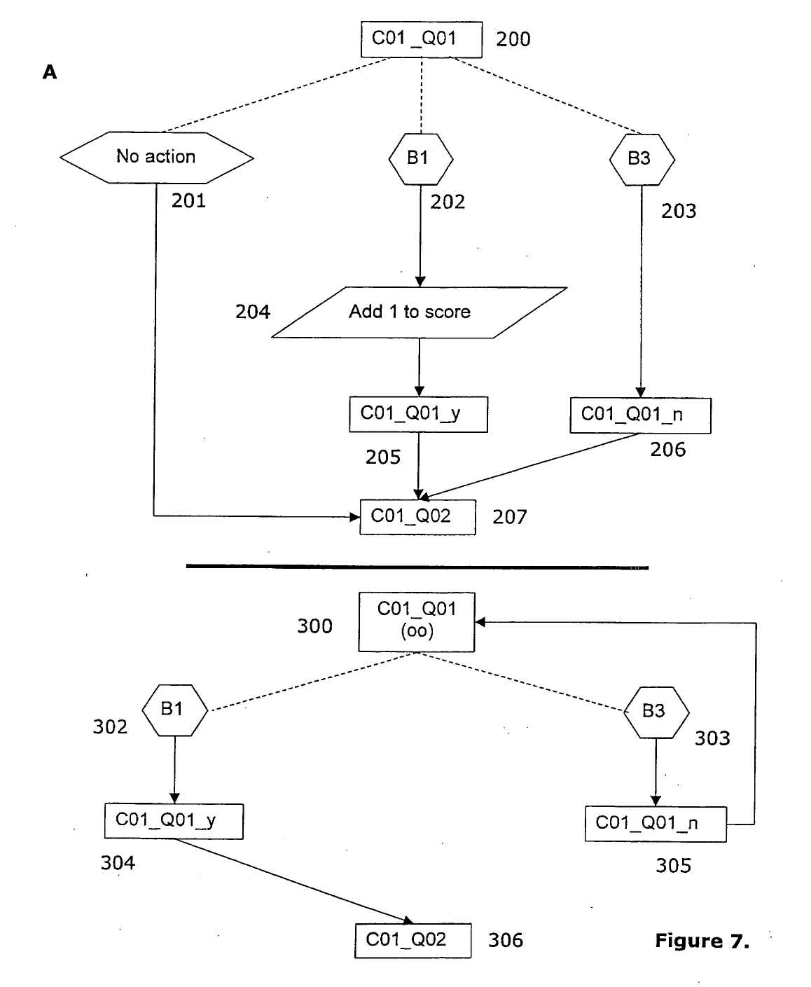

FIG. 7 discloses the programming of a disk for a simple game. The game comprises asking the player questions (quiz) with two or more answer possibilities. The time allowed to answer each question can be limited (FIG. 7.a) or not limited (FIG. 7.b).

The game starts by playing a question video segment (200). The dashed lines show the command link provided by the user. In this game the time to answer each question is limited, then a video segment is played (200), where the segment is of a certain length. If no answer is provided, i.e. no action (201) before the question segment reaches it's end, the game goes to the next question. If the question is answered by pressing the button B1 (202), indicating the correct answer, one point is added to the score list (204) for the player and then a game reacts by playing a short reaction sequence (205) appropriate for the right answer. Thereafter the game goes on to the next question. If button B2 (203) representing the wrong answer is pressed, no point is added to the sore list and a short reaction sequence (206) appropriate for the wrong answer is played and then the game goes on to the next question (207).

In FIG. 7.b. programming for a different game is disclosed, where there is no time-limit for answering the questions and the game is a “try again” game, such that if the wrong answer is given, the player gets an opportunity to answer the question again. In this game the there is no time limit to answer each question and the (oo) sign indicates an infinite looping of the question sequence (301). If the question is answered by pressing the button B1 (302), indicating the correct answer the game reacts by playing a short reaction sequence (304) appropriate for the right answer. Thereafter the game goes on to the next question. If button B2 (303) is pressed, representing the wrong answer, a short reaction sequence (305) appropriate for the wrong answer is played and then the game goes on to the next question (306).

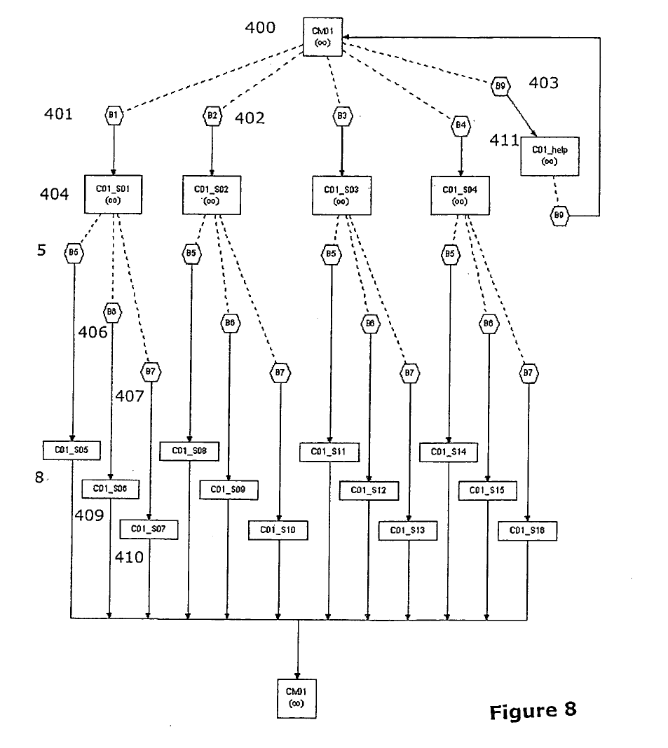

FIG. 8 discloses a programming of a disk for an interactive animated story. The story starts by playing of an introduction sequence (400), which has an infinite running time. If button B1 (401) is pressed, a topic-related menu (404) is initiated, which is presented in an infinite sequence, giving the player 4 options. By pressing buttons B5, B6, or B7 (405, 406, 407) an animated sequence (408, 409 or 410) is initiated. When the sequence reaches it's end the introduction sequence (400) is displayed and a new topic can be selected by pressing for example B2 (402) and a new topic-related menu can be selected. By pressing button B9 (403), help is provided (411) and the B9 is pressed again for returning to the introduction sequence (400). If the player presses the button for a different sequence, than the sequence which is being played at that time, the new sequence starts to play right away, so that there is no need to return to the main menu for selecting a new animated sequence. If buttons B1, B2 or B3 are pressed at any point, the player returns to the introduction sequence.

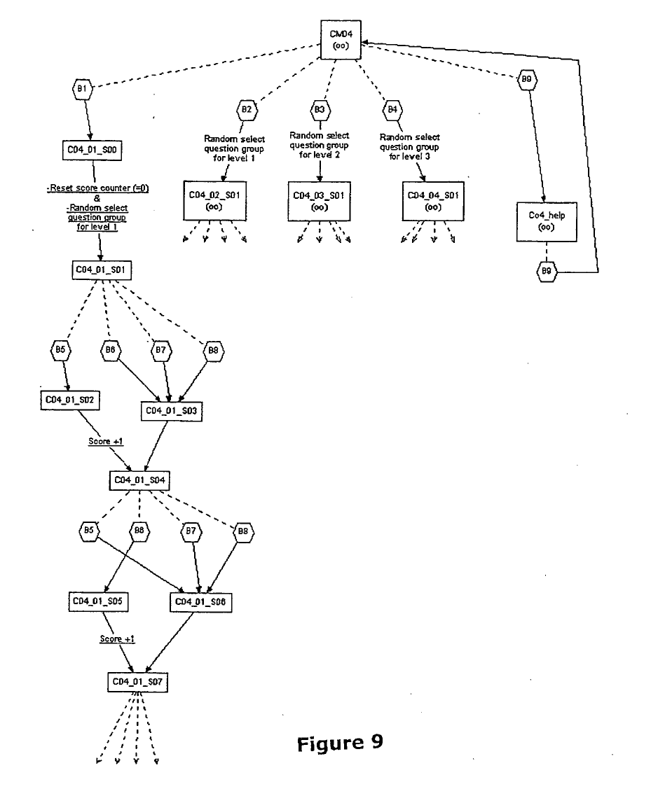

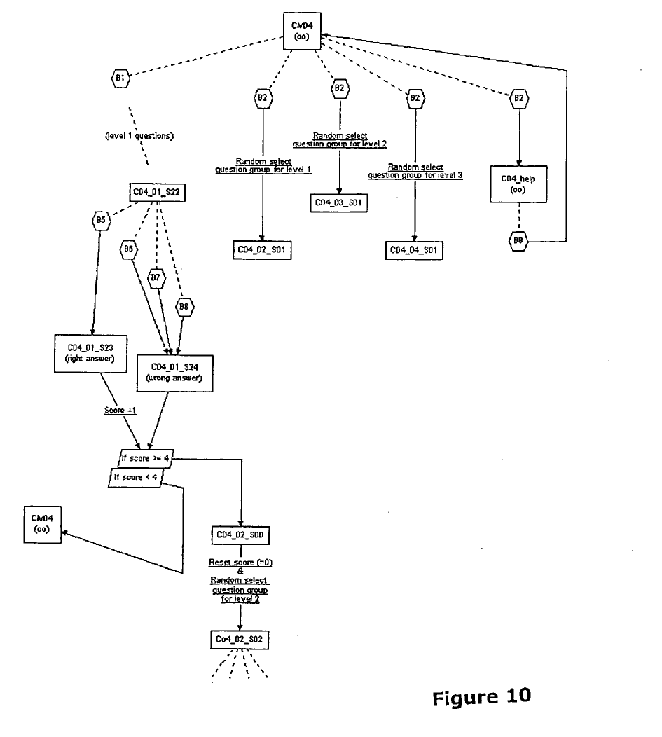

FIG. 9 discloses the programming of a disk for a multi-level quiz game with two or more answer possibilities. The quiz starts by playing of an introduction sequence representing a plurality of question groups and a help option. In this example there are 8 questions in each random select question group for three different levels (FIG. 9a). In the beginning the counter is reset to zero and each correct answer selected from four possible answers adds 1 point to the score list. After all the questions in the question group have been answered a certain amount of correct answers (four in this case) allow the player to proceed to the next level of questions, whereas less than four correct answers redirect the player to back to the beginning. By pressing button B9, help is provided and the B9 is pressed again for returning to the introduction sequence (FIG. 9b).

The operation of the console will appear from the details of operation of an embodiment given below. The details are given in order to make a skilled person able to perform the invention, but do not limit the invention.

The console is based on the Universal Infra-Red Remote Control technology. The console is programmed by inserting the provided “Programming Card” in the console device and entering codes in this program mode. These codes are determined according to the brand and type of the user's DVD player corresponding to a Brand Setup Code list.

If no code is available for the user's DVD player type, the bi-directional Step-N-Set feature is available. As a last resort, the device is also able to learn each necessary IR-codes from the original DVD remote control.

This console is designed for children from 2 year old to operate standalone DVD players with DVD-discs especially formatted to fit with the corresponding cards. By inserting different laminated cards in the remote console, the TV screen appearance changes according to the related content of the disc. Each program is delivered with at least 1 DVD video disc and up to 16 laminated control cards (including 1 an optional programming card).

The Console can also be used as a communication station with DVD players, Set-Top-Boxes for TV and computer where other devices can be connected to the console, for example dancing mattress or other toys that are used in conjunction with the programs.

Navigation into programs is done by inserting cards in the device that automatically selects a sub-menu or track number or chapter by sending an IR signal to the DVD player. By inserting a playing card, a combination of 6 switches is activated, the console then transmits the corresponding chapter number, title, chapter or track and enables the keypad (9 buttons) on the console, as well as right and left button (Play & Pause in normal mode). All buttons are disabled when no card is in the device. With a playing card inserted, the selection or navigation in each sub-menu is done by pressing the corresponding illustration on the card (keys 1 to 9). By this action, the user presses one of the 9 keys on the console and the corresponding chapter, title or track shall be transmitted.

Six sensors are used to detect different cuttings. Sensors 1 and 6 are used only to check the correct inserting of the card. Therefore, they must be present in all combination.

When the programming card is inserted, the remote console emits one beep and the chip is set to “programming mode”, waiting for the user's next action.

Normal Programming Mode:

1) Insert programming card. Device emits one strong beep. The chip is ready for programming.

2) Look up the brand name and type of the DVD player you want to interact with in the user's manual code list.

3) Enter the three-digit code for the corresponding device.

4) Device recognizes and memorizes the code and emits 2 strong beeps.

5) Remove Programming Card. Chip exits the programming mode and device emits 1 strong beep.

Auto-Search Programming Mode:

1) Turn on the DVD player. Insert programming card. Device emits one strong beep. The chip is ready for programming.

2) Aim the device at the DVD player and press the left button once (“pause” in normal mode). The device starts browsing its entire signal library by sending sequentially an On/Off signal. To make the user sure that the device is operating, it emits one low beep with every signal.

3) When the DVD player turns off, the user presses immediately the left button again. Device recognizes and memorizes the code and emits 2 strong beeps.

4) Remove Programming Card. Chip exits the programming mode and device emits 1 strong beep.

5) If no codes have been found and the entire library has been browsed, device emits 3 strong beeps and stops sending signals.

Learning Programming Mode:

1) Put the device on a flat surface along with the DVD player's remote control. The remote control must be aimed at the IR receiver on the lower part of the console device

2) Insert programming card. Device emits one strong beep. The chip is ready for programming.

3) Press the right button once (“play” in normal mode). Device emits 1 strong beep and chip is ready to memorize the signals from the IR receptor.

4) Press the “TOP MENU” button on the remote control (a.k.a. “DVD MENU”, “TITLE MENU”, “ROOT MENU” etc.). DVD-kids device emits one low beep and stores the signal.

5) Press successively first on the DVD-kids™ device and then on the remote control the buttons 1, 2, 3, 4, 5, 6, 7, 8, 9, pause, play. Device emits 1 low beep each time a signal is identified and stored.

6) After the “play” button has been pressed and the device has stored all signals, it emits 2 strong beeps.

7) Remove Programming Card. Chip exits the programming mode and device emits 1 strong beep.

Other programming features may be used, as described below.

The console may have the following features:

11 physical keys (and possibly 1 hidden key)

6 mechanical switches for card detection

Universal DVD, worldwide load

Learning (custom)

Direct set (custom)

Bi-directional Step-N-Set (custom)

Blink Out (custom, audible feedback)

Stuck Key time-out

Code Verification (custom)

1 beeper for audible feedback

24K microprocessor—Samsung S3P/C80F9XLP-SOB7 (SOP-32pin)

3 IR LEDs

1K EEPROM

4AA-6-volt product

The Device has 4 modes in the way of sending signal to the DVD player.

Mode 1. sends “ENTER” after each numeric signal

Mode 2 sends numeric signal alone.

Mode 3 sends “0” in front of numeric signal.

Mode 4 sends “0” ind front of numeric signal and “ENTER”

Default mode is Mode 1.

The keys may have the following features:

Play: This is the big button at the right hand side of the device. The button may be blue. This key transmits the Play function in normal operation mode. For ID's that have a combined Play/Pause key, the Play key is used for the Play/Pause toggle function. When the programming card is inserted, this key may function as an internal digit 0 during direct set & ID code verification (Not IR digit 0). This button can also be used to start the “learning” programming mode.

Pause: This is the big button at the left-hand side of the device. The button may be yellow. This key transmits the Pause function in normal operation mode. This button can also be used to start the “auto-search” programming mode.

Digits (1-9): These keys function as regular digit keys in every mode.

The described embodiment may have one or several of the following features:

Audible feedback (beep): Audible feedback is used for user feedback and for confirmation of programming sequences.

Short Beep: Time duration for the short beep is 150 msec. Short beep signals a valid key press. Multiple short beeps convey information to the user or signal a programming sequence. Delay between short beeps will be 200 msec.

Long Beep: Time duration for the long beep is 600 msec. Long beeps signify invalid key sequence or bad or no EEPROM installed.

Boot up Beep: The device will generate 2 short beeps when batteries are applied to a previously uncharged device. No EEPROM or bad EEPROM will generate two short beeps and one long beep.

Time-Out: If 20 seconds has elapsed after a key press, the remote will exit the programming state or current state.

Stuck Key Time-Out: After any key is pressed continuously for 20 seconds, the remote will stop IR transmission to conserve battery life.

Simultaneous Key Press: If more than one key is pressed simultaneously, IR transmission will stop until all the keys are released, and then the remote will go into Stop Mode.

Stop Mode: This is the idle state of the micro-controller when it draws the least amount of current. This is entered by executing the Stop command in the internal firmware.

Unassigned Keys: The remote control shall ignore any unassigned key presses for a particular mode and not transmit IR unless otherwise noted.

ID—Number of Digits: Each ID code or set up code consists of four digits from 0 to 9 and is defined in the main UEI database.

Power Up with Default Device Mode and Codes: The standard console operation at initial power up shall default to the DVD mode. Other modes can be Set-Top-Box mode, PC mode or similar for the different devices it is meant to operate. The unit shall generate 2 short beeps at initial power up.

Normal Operation: During normal operation, when a playing card or a programming card is successfully inserted, the console shall generate a short beep with every key press, unless otherwise stated. When no playing card or programming card is inserted, the console shall not react on a key press, e.g. no IR shall be transmitted and no beep shall be generated.

Playing/programming card insertion: The user has a maximum of 15 playing cards and 1 programming card. When inserting a card, a combination of 6 sensors is activated to detect the card number, one short beep shall be generated and the corresponding digit (title, chapter or track number) shall be transmitted. When the combination of sensors is unknown, 1 long beep should be generated. After inserting the Programming Card (there's only 1), no IR is transmitted and the console goes into ‘programming mode’. Only in this programming mode it is possible to program the console, e.g. to setup an ID, access Bi-directional Step-N-Set, enable learning, etc. After each successful programming sequence, the remote will exit the programming mode. The programming card needs to be removed and inserted again before starting another programming sequence. To terminate the programming sequence the program card may be pulled out of the console at any time. One long beep shall be emitted to indicate an unsuccessful programming sequence.

Playing-/Programming card removal: When a playing card is removed from the console, the command ‘Top Menu’/‘Title Menu’/‘Title’ shall be transmitted and a short beep shall be generated. The removal of the playing card can be determined by the de-activation of the mechanical switches. When the programming card is removed, no commands shall be transmitted.

Set Up “Direct set”.

The four-digit target device ID code obtained by the user from the product code book shall be programmed as follows:

Insert Programming Card→Digit→Digit→Digit→Digit

Programming card must be successfully inserted, indicated by 2 short beeps. The console shall generate 1 short beep after each digit entry, except for the last digit. For the last digit, the remote generates 2 short beeps to confirm that a valid code has been programmed. The programmed ID shall be stored in EEPROM and the unit will exit the programming mode. Since the remote only has 9 digit keys, the Play key acts as digit “0” whenever the programming card has been successfully inserted and the Play key is pressed less then 2 seconds.

The unit automatically exits the programming mode, returns to the idle mode and restores the last preprogrammed code under two conditions:

1. when the four-digit code is not entered within 20 seconds

2. when an invalid code is entered upon which the alarm or piezo shall generate a long beep.

To terminate the programming sequence the program card may be pulled out of the console at any time. One long beep shall be emitted to indicate an unsuccessful programming sequence.

Bi-Directional SteD-N-Set “Advance Search”:

Insert Programming Card→<<Pause>>→Play/Pause→<<Pause>>

DVD player must be manually switched on and a DVD must have been inserted.

Programming card must be successfully inserted, indicated by 2 short beeps

Press and hold the Pause key for 2 seconds (<<Pause>>). The device will generate 2 short beeps to confirm the Bi-directional Step-N-Set mode

Press the Play key to step through the ID's one by one, transmitting the Play command with each key press, starting with the most popular code and works it's way down to the least popular code. The console shall generate 1 short beep with each key press of the key to confirm each code transmitted. Once the correct ID has been selected, the DVD Player should start playing the DVD.

Press and hold the Pause key for 2 seconds (<<Pause>>) to store the selected ID in EEPROM. The console will generate 2 short beeps to confirm successful programming.

If the user accidentally pressed the Play key too quickly and passed onto the next ID with the DVD player starting to play on the previous ID, the user can press the Pause key shortly (less then 2 second) to scroll backwards through the ID's one by one (The DVD player should pause).

The bi-directional Step-N-Set function has an end of cycle designator (indicated by 3 short beeps) to indicate when a cycle has been completed. The unit shall begin to cycle through the available codes again, starting with the most popular code.

The console automatically exits the programming mode, returns to the idle mode, generates a long beep and restores the last preprogrammed code under two conditions:

1. when any key other than the Play or Pause key is pressed

2. when no key is pressed within 20 seconds

To terminate the programming sequence the program card may be pulled out of the console at any time. One long beep shall be emitted to indicate an unsuccessful programming sequence.

ID Code Verification (990): The device ID code for a mode shall be verified as follows:

Insert Programming Card→9→9→0→1(count beeps)→2(count beeps)→3(count beeps)→4(count beeps)

Programming card must be successfully inserted, indicated by 2 short beeps. The number of beeps counted after pressing each digit 1, 2, 3, and 4 key shall represent the 4-digit device ID code for the selected mode beginning with the left most digit. The delayed start of the beeps shall be 0.5 seconds with a 0.5 second delay after each key press for digit 1,2,3 and 4. The remote shall exit the ID Code Verification state when, after performing the sequence 9→9→0, the user presses any key other than digit 1. If the sequence of pressing digits 1, 2, 3, and 4 for counting blinks is not maintained, the remote shall exit the ID Code Verification state. Operation error and state exit shall be marked by the alarm or piezo generating a long beep. The console shall time out after 10 seconds during programming.

To terminate the programming sequence the program card may be pulled out of the console at any time. One long beep shall be emitted to indicate an unsuccessful programming sequence.

ID Off-set: A fixed value added to the standard UEI Device ID codes in a particular model UEI remote. Used in some OEM and Private Label products to differentiate these from OFA products by making the UEI Device ID Codes appear different in the User Code Book:

3-Plus Kids DVD=+30

Learning Capability: The Learning feature is used as a supplement to a standard pre-programmed library. In the unlikely event that a code is missing, the user can add a small number of commands.

Insert Programming Card→<<Play>>→Key to be learned→<<Play>>

Learning Operation:

1. Programming card should be successfully inserted.

2. User presses and holds the Play key for 2 seconds (<<Play>>). The device shall generate 2 short Beeps to confirm the learning mode.

3. Press the ‘Key to be learned’ (time-out if no key pressed within 20 seconds), the unit will generate short beeps rapidly (time-out if no received signal detected in 20 sec). To learn the hidden ‘Top Menu’ key, press the Play and Pause key together.

4. Hold teaching remote close to IR LED and press key to be taught.

5. Beeper will switch off if signal is received. Continue to press teaching key until double beeps sounds from the piezo. A long beep indicates unsuccessful learning.

6. Repeat steps 3 through 5 as often as desired (up to limit of memory).

7. Exit learning mode by pressing <<Play>>, the unit will generate 4 short beeps when exiting or by 10 second time-out.

At step 6, one long beep indicates learning failure, which could be: Bad capture (try again); Memory full (delete some other function); or Unlearnable code

At step 2, one long beep is generated if faulty E2 is detected.

The execution of the Factory Test Mode (FTM) will delete all of the learned functions.

Limitations on Learning:

There are certain device codes that may not be learnable. These include multi-frequency codes (e.g. Telefunken), some high frequency codes, and other unusual formats.

The learner will support I.R. codes with carrier frequencies up to 135 KHz.

Maximum code gap is 131,070 microseconds.

The number of learned keys is limited by the size of E2. Capacity is approximately 12 keys for 1K.

The source and target remote should be no more than 2 inches apart.

The learning event should be conducted in low levels of natural light or fluorescent lights.

To terminate the programming sequence the program card may be pulled out of the console at any time. One long beep shall be emitted to indicate an unsuccessful programming sequence.

Low Voltage Detection: Low voltage detection is controlled by hardware (Samsung™ chip). The low voltage condition is recognized by software as an external reset. The console shall generate 4 short beeps and not transmit IR when the low voltage condition is initially reached. While in the low voltage condition, the unit will not operate.

Memory Retention—Long Term: The programmed target device codes shall be saved in EEPROM upon power outage or battery removal. The device codes and learned data shall be permanently retained; all units are equipped with EEPROM.

Simultaneous Double Key Press—Standard Action: Upon detection of a simultaneous double key press, the unit will stop sending all IR signals until all depressed keys are released. After release of all depressed keys, IR will be sent upon a single key press as per standard operation.

Stuck Key Time Out: The remote shall stop transmitting IR and conserve power upon any key depressed longer than 20 seconds.

High Frequency IR: Primarily for the European marketplace, Samsung™ micro controllers are capable of operating up to 450 KHz carrier frequencies.

Factory Test Mode: The console shall enter FTM when no playing card or programming card is installed and batteries are inserted:

Within 6 seconds after applying power to the unit, the Play and Pause keys should be simultaneously pressed to enter the FTM.

The 1 k EEPROM shall be cleared and initialized (Factory Reset). Indicated by 2 short beeps.

Within 10 seconds, the programming card shall be inserted to activate & test all 6 mechanical switches. IR shall be transmitted (as indicated in below table, key number 12) and 2 short beeps shall be generated to indicate correct functioning of the 6 switches.

If there is a malfunction on 1 or more of the 6 mechanical switches the remote should generate 1 long beep and transmit IR (as indicated in below table, key number 13)

If within 10 seconds the Play key is pressed (before the programming card has been inserted), the remote shall generate 4 short beeps and exit FTM. (Indicating successful Reset)

If the programming card is not inserted within 10 seconds or the Play key has not been pressed, the remote shall generate 1 long beep and exit the FTM.

If within the 10 seconds a playing card is inserted, exit FTM, generate a long beep and return to normal operation.

Within 10 seconds after insertion, the programming card shall be removed. 4 short beeps shall be generated.

After each key press, the user has 30 seconds to press the next key. When a key is not pressed within 30 seconds, the remote will exit FTM, generate a long beep and return to normal operation.

During IR transmission the beeper will generate short beeps rapidly.

When in FTM, each key will send a unique code based on the actual scan code assigned to each key. Please refer to the table below.

Operational feature multiple key press is applied during FTM.

All operational features are not available during FTM.

Hereinabove has been described an embodiment and several features thereof. It is realized that the features may be combined in different manners than those described and such combinations should be included within the scope of the invention. The invention is only limited by the appended patent claims.

In a specific embodiment of the present invention a card can represent the remote control for a DVD player to play regular DVD disks. This may be accomplished by including a standard card for playing a regular disk or a tailor made card for each DVD disk, for example, a carton movie. The card will then induce functions like play, stop next, previous or following a menu with horizontal and vertical arrows as shown in FIG. 5.

### EXAMPLES

### Example 1

### PIXELINE for DVD-Kids

This example describes how a certain game (Pixeline) is played using the DVD-kids platform.

The playing is initiated as the player inserts a disc in the DVD player. When the disc is inserted in the DVD player, the player automatically plays the standard dvd-kids intro clip.

Player then goes to the TOP MENU* and waits for insertion of a card in the console. The DVD player auto plays an introduction clip and thereafter goes to the TOP MENU. The TV screen display shows the introduction clip followed by the TOP MENU.

The TOP MENU is a lightly animated screen that could be compared to the Title Menu or Top Menu of a regular DVD. In the present example, no choice is possible on the screen (buttons or scrolling menu), but when a card is inserted in the console, it sends a signal to the player. The operation is similar to pressing a number on a regular DVD remote control to directly select an access in a multiple entry menu.

After playing the intro clip or when removing a card from the console at any point on the disc, the player must go back to the TOP MENU. The console sends the TOP MENU signal to the player (also called TITLE MENU or even DVD MENU on some remote controls). To avoid automatic playback of the last sequence played as it occurs on most DVD players, authoring of the disc must discard this resume playing function.

When a card is inserted in the console, the display reverts from the TOP MENU. The DVD player automatically displayes the corresponding Card Menu Screen on the TV screen and waits for the viewer to press one of the available buttons. The corresponding “zoom in” effect on the card must be always played between the TOP MENU and the Card Menu screen.

Upon removing the card, the “zoom out” effect is played between the Card Menu screen and the TOP MENU.

The process is described in the following tables starting from the corresponding Card Menu Screen

TABLE 1

| Legend | Action |
|---|---|
| BUTTON | buttons activated by viewer |
| ACTION | DVD player's action according to corresponding |
| | button |
| DESTINATION | DVD player's target on the disc according to |
| | corresponding button |
| PROGRAM | programming requirement to process operation |
| TV SCREEN | TV screen appearance |
| END | DVD player's action when object reach its end |

Empty field means no object

When a sequence is selected on the card inserted in the console, it is always possible to select another sequence on the same card without waiting for the Card Menu to come back on the screen. This is obtained by the Random/Shuffle feature.

In cards n°1 (Jungle hide and seek game) and n°6 (Sheep haircuts), shuffle feature is preferably used over the random feature. This ensures that the same sequence will not be played several time (or under different button) during the game. This is further explained here below:

Random: DVD player is told to pick and play one of the sequence in the defined group. Unfortunately later in the game, the same sequence is possibly picked and played again under the same or another button.

Shuffle: DVD player is told to pick and play one of the sequence in the defined group and then “remember” that this sequence has been played already. The same sequence cannot be shown twice during the same session. When the card is removed from console, this feature should then be “cleared” to make possible another game if the same card is inserted again.

Sound Effects.

There is a sound loop in Card Menus and the TOP MENU. As it has not been mixed while creating the animated Card Menus, the music loop is added before final authoring. Each card has a specific music playing in the background of the sequences. A CD is attached to the material with “Effects and Music” only (no voices). This provides a cut around 30 seconds of music and loops it on the corresponding Card Menu. The music loop for TOP MENU is the same as for Intro Card Menu (card n^{o}7).

Zoom In/Out for TOP MENU Transitions

The ZOOM OUT and ZOOM IN effects are the same sequence, where the ZOOM IN sequence is played backwards for the ZOOM OUT.

TABLE 2
ZOOM IN. When a card is inserted in console, the corresponding
“zoom in” sequence is played as followed:

| STATE | | INDUCED | |
|---|---|---|---|
| ON TV | ACTION BY | ACTION BY | TV SCREEN |
| SCREEN | USER | PLAYER | ASPECT |
| TOP MENU | insert any of | play “zoom in” clip | image is zooming |
| screen | the 7 cards | corresponding to the | on the inserted card |
| | in console | inserted card | displayed in TOP |
| | | AND | MENU screen |
| | | go to the Card Menu | AND |
| | | Screen | card fill the TV |
| | | corresponding to | screen (Card Menu |
| | | the card inserted | screen) and viewer |
| | | in console | is able to interact |
| | | | with the buttons |

TABLE 3
ZOOM OUT. When the card is removed from Console, the
corresponding “zoom out” sequence is played as followed:

| STATE | ACTION | INDUCED | |
|---|---|---|---|
| ON TV | BY | ACTION BY | |
| SCREEN | USER | PLAYER | TV SCREEN ASPECT |
| CARD | remove | play “zoom out” | image is zooming out |
| MENU | the card | clip corresponding | of the removed card, |
| screen | from | to the removed | picture going wider on |
| | Console | card | the TOP MENU screen |
| | | AND | AND |
| | | go to the TOP | TOP MENU on screen, |
| | | MENU Screen | waiting for the viewer |
| | | | to insert any of the 7 |
| | | | cards |

Tables 4 and 5 show the process as no cards or a specific card is inserted in the console.

TABLE 4
NO CARD - TOP MENU screen When no card is inserted, TOP MENU
clip (animated menu) is played in loop.

| CARD INSERTED | ACTION | DESTINATION | PROGRAM | TV SCREEN | END |
|---|---|---|---|---|---|
| 1- Jungle | go to | Jungle Card | no specific | Jungle Card | |
| | | Menu | programming | Menu | |
| 2- Farm | go to | Farm Card Menu | no specific | Farm Card | |
| | | | programming | Menu | |
| 3- Counting | go to | Counting Card | no specific | Counting | |
| | | Menu | programming | Card Menu | |
| 4- Drawing | go to | Drawing Card | no specific | Drawing Card | |
| | | Menu | programming | Menu | |
| 5- Dancing | go to | Dancing Card | no specific | Dancing Card | |
| | | Menu | programming | Menu | |
| 6- Sheep | go to | Sheep haircut | no specific | Sheep haircut | |
| haircut | | Card Menu | programming | Card Menu | |
| 7- Intro | go to | Intro Card Menu | no specific | Intro Card | |
| | | | programming | Menu | |

Inserting a card in Console has the same effect as pressing 1, 2, 3, 4, 5, 6 or 7 on a the regular DVD player's remote controller.

Table 5 shows how Pixeline is giving 6 funny haircuts to her friends the sheep. Each available button plays a different haircut. A random (or shuffle if possible) feature ensure that each time the viewer play with this card, haircuts are under different buttons.

TABLE 5
CARD #6 - Sheep haircut.

| | | | | TV | |
|---|---|---|---|---|---|
| BUTTON | ACTION | DESTINATION | PROGRAM | SCREEN | END |
| 1- haircut 1 | go to | haircut clip | clip randomly | haircut clip | go back |
| | | | selected | | to |
| | | | (shuffle if | | Sheep |
| | | | possible) | | Card |
| | | | | | Menu |
| 2- haircut 2 | go to | haircut clip | clip randomly | haircut clip | go back |
| | | | selected | | to |
| | | | (shuffle if | | Sheep |
| | | | possible) | | Card |
| | | | | | Menu |
| 3- haircut 3 | go to | haircut clip | clip randomly | haircut clip | go back |
| | | | selected | | to |
| | | | (shuffle if | | Sheep |
| | | | possible) | | Card |
| | | | | | Menu |
| 4- haircut 4 | go to | haircut clip | clip randomly | haircut clip | go back |
| | | | selected | | to |
| | | | (shuffle if | | Sheep |
| | | | possible) | | Card |
| | | | | | Menu |
| 5- haircut 5 | go to | haircut clip | clip randomly | haircut clip | go back |
| | | | selected | | to |
| | | | (shuffle if | | Sheep |
| | | | possible) | | Card |
| | | | | | Menu |
| 6- | | | | | |
| 7- | | | | | |
| 8- | | | | | |
| 9- haircut 6 | go to | haircut clip | clip randomly | haircut clip | go back |
| | | | selected | | to |
| | | | (shuffle if | | Sheep |
| | | | possible) | | Card |
| | | | | | Menu |
| Removing | go to | TOP MENU | no specific | TOP MENU | |
| card from | | screen | programming | screen | |
| remote | | (plays “zoom | (except if | (plays | |
| control | | out” animation | “zoom out” | “zoom out” | |
| | | before TOP | feature) | animation | |
| | | MENU if possible) | | before TOP | |
| | | | | MENU if | |
| | | | | possible) | |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### Example 2

### Programming Disks for DVD-Kids™

1. A control device for a video player comprising:
a console, further comprising a robust body with round corners and a handle grip;
a first group of sensors;
a second group of sensors;
a communication device for transmitting control signals to said player;
a plurality of cassettes detachably mountable on said console, the cassettes cooperating with said first and second group of sensors to provide said control signals; and
one of the cassettes being a programming cassette, the programming cassette when mountable on the console to program the control signals to a video player.

2. The control device of claim 1, wherein the control device is for a DVD player and wherein when one of the cassettes of the plurality of cassettes is mounted on the console, it covers a portion of the surface of the console.

3. The control device of claim 1, wherein said programming cassette has a first set of actuators for cooperation with said first group of sensors and a second set of actuators for cooperation with said second group of sensors.

4. The control device of claim 2, wherein said first set of actuators work with said first group of sensors to transmit a control signal to said console to put said console in a programming mode.

5. The control device of claim 1, wherein said cassettes are provided with at least one of figures and pictures overlying said second group of sensors.

6. The control device of claim 1, wherein said communication device comprises an infrared light transmitter.

7. The control device of claim 1, wherein said communication device comprises an infrared light receiver.

8. The control device of claim 1, wherein said programming cassette comprises nine digits overlaying nine corresponding buttons of said console for activating said buttons for emitting programming signals to said control device.

9. A system for children to interact with a video player comprising:
a control device having a console with a robust body, round corners and a handle grip, the control device further having a first group of sensors, a second group of sensors and a communication device, control signals being transmitted by the communication device to a video player;
a DVD player;
a monitor;
a DVD disk; and
a plurality of cassettes being mountable on said console, and for cooperation with said first and second group of sensors, for providing said control signals, the plurality of cassettes including a programming cassette, the programming cassette when mountable on the console to program the control signals to the DVD player.

10. The system of claim 9, wherein when one of the cassettes of the plurality of cassettes is mounted on the console, it covers a portion of the surface of the console.

11. The system of claim 9, wherein said programming cassette has a first set of actuators for cooperation with said first group of sensors and a second set of actuators for cooperation with said second group of sensors.

12. The system of claim 11, wherein said first set of actuators work with said first group of sensors to transmit a control signal to said console to put said console in a programming mode.

13. The system of claim 9, wherein said cassettes are provided with at least one of figures and pictures overlying said second group of sensors.

14. The system of claim 9, wherein said communication device comprises an infrared light transmitter.

15. The system of claim 9, wherein said communication device comprises an infrared light receiver.

16. The system of claim 9, wherein said programming cassette comprises nine digits overlaying nine corresponding buttons of said console for activating said buttons for emitting programming signals to said control device.

17. A method for children to operate and interact with a standalone video player through a control device having a console, the method comprising the steps of:
placing a DVD-disk in a DVD player;
programming the console/DVD player by placing a programming card on the console;
placing one of a plurality of cards on the console for cooperation with a first group of sensors on the console, the sensors providing control signals and the card being one of a cassette, playing card and interactive card;
navigating into programs through a second group of sensors by pressing sensors through at least one of signs, figures, letters and pictures on the cassette cards;
automatically selecting one of a sub-menu, track number and chapter on the DVD-disk by sending an IR signal to the DVD player when the card is placed on the console and during the step of navigating; and
programming the console with a programming card so that the console will interact with the DVD player.

18. The method of claim 17, wherein the step of placing a card includes covering a portion of the surface of the console with the card.

19. The method of claim 17, wherein the plurality of cards include a programming cassette, the programming cassette has a first set of actuators and a second set of actuators, the method comprising the step of the first set of actuators of the programming cassette cooperating with said first group of sensors and the second set of actuators cooperating with said second set of sensors.

20. The method of claim 19, comprising the step of transmitting a control signal to the console by said first set of actuators working with said first group of sensors to put said console in a programming mode.

21. The method of claim 17, comprising the step of providing said cards with at least one of figures and pictures overlying said second group of sensors.

22. The method of claim 17, wherein the step of programming uses an infrared light transmitter.

23. The method of claim 17, wherein the step of programming uses an infrared light receiver.

24. The method of claim 17, wherein said programming cassette comprises nine digits, the method comprising the step of overlaying the nine digits with corresponding nine buttons of said console for activating said buttons for emitting programming signals to said control device.
